(19) United States
(12) Patent Application Publication
(10) Pub. No.: US 2026/0206056 A1
(43) Pub. Date: Jul. 16, 2026

(54) IN DEVICE COEXISTENCE ENHANCEMENTS UNAVAILABILITY ENCODING AND UHR OPERATING MODE NOTIFICATION FRAME ENHANCEMENTS

(71) Applicant: APPLE INC., Cupertino, CA (US)

(72) Inventors: Abdel Karim Ajami, San Jose, CA (US); Min Young Park, San Ramon, CA (US); Anuj Batra, Redwood City, CA (US); Yoel Boger, Shoham (IL); Leonid Epstein, Herzliya (IL); Yong Liu, Campbell, CA (US); Qi Wang, Mountain View, CA (US); Zhou Lan, Sunnyvale, CA (US); Oren Shani, Saratoga, CA (US); Yan Zhang, Palo Alto, CA (US)

(21) Appl. No.: 19/423,007

(22) Filed: Dec. 17, 2025

Related U.S. Application Data
(60) Provisional application No. 63/744,129, filed on Jan. 10, 2025.

(51) Int. Cl. H04W 74/0816; H04L 1/1607; H04L 5/00; H04W 74/00

(52) U.S. Cl. CPC H04W 74/0816; H04L 1/1614; H04L 5/0053; H04W 74/002

(57) ABSTRACT

Embodiments herein provide methods for access points (APs) and non-AP stations (STAs) to enhance in-device Coexistence indications. In some embodiments, a STA may determine an in-device coexistence condition. The STA may generate a frame that includes a link identifier (ID) indication that indicates Dynamic Unavailability Operation (DUO) Mode enablement for links to which the in-device coexistence condition applies. The STA may send the frame to an AP.

### TECHNICAL FIELD

This application relates generally to wireless communication systems, including enabling Dynamic Unavailability Operation (DUO) Mode for multiple links and providing unavailability information to an access point (AP).

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi^{®}).

In the 802.11 standard for WLAN, an access point (AP) is a device that creates a wireless local area network (WLAN), or Wi-Fi^{®} network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi^{®} protocol. Various protocols have been established to increase security over a wireless communication network. For example, Simultaneous Authentication of Equals is the core authentication protocol of WPA3-Personal, and is mandated to be supported by all Wi-Fi^{®} Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example signaling timeline where a non-AP STA informs an AP 106 of an unavailability duration due to in-device coexistence in accordance with some embodiments.

FIG. 2 illustrates an example signaling timeline where a non-AP STA informs an AP via an ICR of an unavailability duration due to in-device coexistence in accordance with some embodiments.

FIG. 3A illustrates an example table for a protected UHR mode notification frame action field format in accordance with some embodiments.

FIG. 3B illustrates an example DUO parameters field in accordance with some embodiments.

FIG. 4 illustrates an example signaling diagram for a UHR Mode Enablement Notification Frame with a timeout interval in accordance with some embodiments.

FIG. 5A illustrates an example protected EML OMN frame action field format in accordance with some embodiments.

FIG. 5B illustrates an example UHR control field in accordance with some embodiments.

FIG. 5C illustrates an example table that specifies the DUO Mode subfield in accordance with some embodiments.

FIG. 6A illustrates an example signaling timeline for solicited transmission of in-device coexistence unavailability information in accordance with some embodiments.

FIG. 6B illustrates an example signaling timeline for solicited transmission of in-device coexistence unavailability information in accordance with some embodiments.

FIG. 7 illustrates an example flexible TWT operation using TWT information frame in accordance with some embodiments.

FIG. 8 illustrates an example Multi-Link Operation (MLO) Link Information element that may be included in a TWT information frame in accordance with some embodiments.

FIG. 9A illustrates an example TWT Information frame Action field in accordance with some embodiments.

FIG. 9B illustrates an example unavailability parameters field in accordance with some embodiments.

FIG. 10 illustrates a TWT Information field that includes an indication of whether the unavailability parameters are present in accordance with some embodiments.

FIG. 11 illustrates a method performed by a non-AP STA, according to embodiments herein.

FIG. 12 illustrates a method performed by an AP, according to embodiments herein.

FIG. 13 illustrates an example system for performing signaling between a wireless device and a network device, according to embodiments disclosed herein.

### DETAILED DESCRIPTION

Wireless communication technology uses various standards and protocols to transmit data between an access point and a wireless communication device. One standard that is used for wireless communication is Institute of Electrical and Electronics Engineers (IEEE) 802.11 standard for Wireless Local Area Networks (WLAN) (commonly known to industry groups as Wi-Fi^{®}). Wi-Fi^{®} provides a convenient way to establish a network between devices. A device (e.g., a station) may connect to a Wi-Fi^{®} access point to join a network and connect to the internet wirelessly.

An Access Point (AP) is a device that creates a wireless local area network (WLAN), or Wi-Fi^{®} network. A station (STA) is a device that is capable of being wirelessly connected to the AP to join the network. A mobile-AP is a device that can function as a portable AP to provide internet access to nearby STAs. For example, a mobile-AP may be a cellular phone with hotspot mode enabled.

Various embodiments are described with regard to an STA and an AP. However, reference to an STA and an AP is merely provided for illustrative purposes. The example embodiments may be utilized with any electronic component that may establish a connection to a network and is configured with the hardware, software, and/or firmware to exchange information and data with the network. Therefore, the STAs and APs as described herein are used to represent any appropriate electronic component.

In-device coexistence is a feature that allows a device to manage and mitigate interference between multiple wireless radios operating within the device. For example, a device may include multiple STAs capable of establishing connections with multiple APs. For instance, a device may support the use of multiple Wi-Fi radios on different frequencies to establish sessions with multiple APs. In-device coexistence may allow the device to operate multiple STAs while mitigating conflicts between the communication sessions.

A non-AP STA may inform an AP of an in-device coexistence condition. Embodiments herein include enhancements to the reporting of in-device coexistence. Some embodiments provide enhancements to the in-device coexistence protocol. This may allow a client device to inform an AP that the client device is experiencing in-device coexistence.

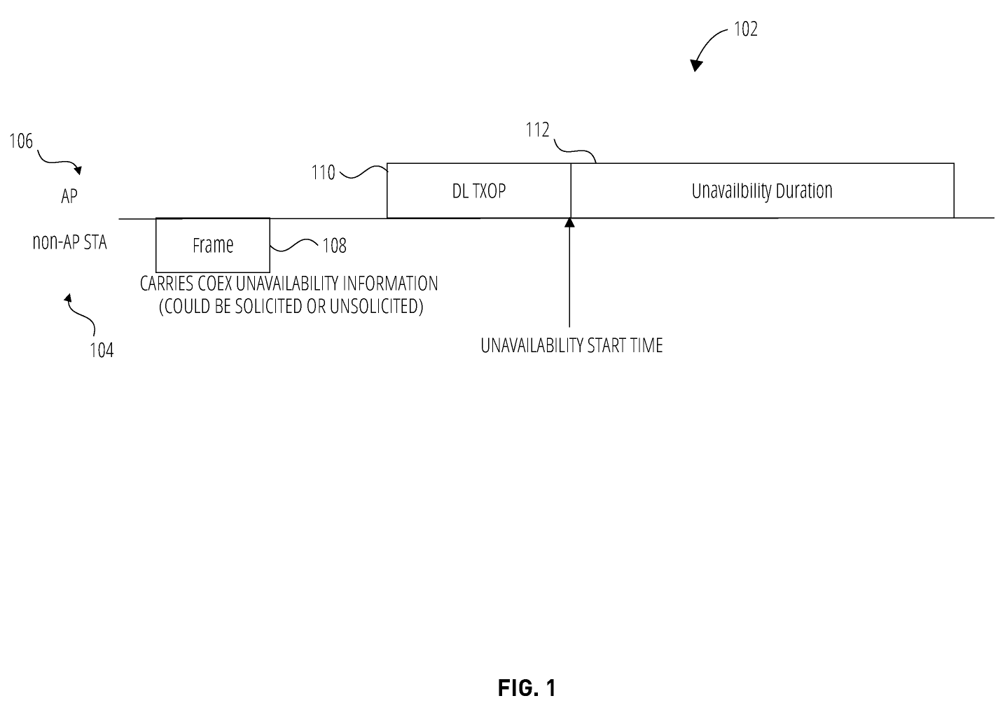

FIG. 1 illustrates an example signaling timeline 102 where a non-AP STA 104 informs an AP 106 of an unavailability duration due to in-device coexistence in accordance with some embodiments. The unavailability information may be included in a frame 108 sent by the non-AP STA 104. In some embodiments, the frame 108 may be an Initial Control Frame (ICF) or an initial Control Response (ICR). The non-AP STA 104 may notify the AP 106 about its future unavailability due to in-device coexistence whenever it is experiencing a coexistence session using the frame 108. The frame 108 may be solicited or unsolicited and include unavailability information.

Sending the unavailability information may enhance the performance of the wireless communication system by reducing data loss, failed transmissions, and preventing unnecessary transmit rate reduction. For example, the AP 106 may schedule a downlink transmission opportunity 110 before the unavailability duration 112 that is indicated in the frame 108.

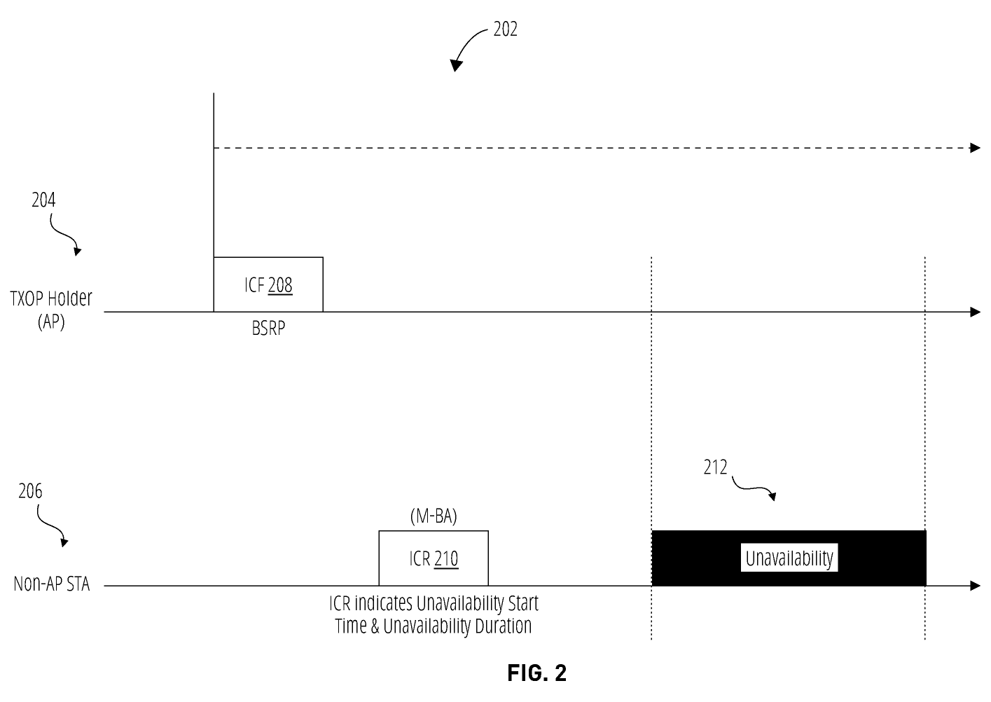

FIG. 2 illustrates an example signaling timeline 202 where a non-AP STA 206 informs an AP 204 via an ICR 210 of an unavailability duration due to in-device coexistence in accordance with some embodiments. The non-AP STA 206 may inform the AP 204 about an in-device coexistence condition using a management frame. In response the AP 204 may request unavailability information from the client non-AP STA 206. In this way the AP 204 may obtain knowledge about the in-device coexistence operation mode of the non-AP STA 206.

For example, the AP 204 as a transmission opportunity (TXOP) holder can send an ICF 208 to solicit the unavailability information from the client (e.g., non-AP STA 206). The ICF is a Buffer Status Report Poll (BSRP) trigger frame. Once the AP 204 sends the ICF 208, then the non-AP STA 206 responds to the ICF 208 with an ICR 210 frame that carries the unavailability information.

The unavailability information may indicate details of a period of unavailability 212 due to in-device coexistence. In the illustrated embodiment the unavailability information in the ICF 208 includes an unavailability start time and unavailability duration. For example, in the illustrated embodiment, the non-AP STA 206 indicates that the period of unavailability 212 occurs during bits 15 to 7 of the Timing Synchronization Function (TSF). Based on the unavailability information (start time and duration) in the ICR 210, the AP 204 should not schedule for transmission Physical Protocol Data Units (PPDUs) addressed to the non-AP STA 206 that overlaps with its unavailability.

The in-device coexistence future unavailability start time can enable the non-AP STA 206 to indicate its unavailability ahead of time to the AP 204. The reasons why it may be useful for the non-AP STA 206 to indicate the unavailability start time include the following. Due to a busy medium, the non-AP STA 206 may not have access to the channel right before start time. Further, without the Unavailability information, the AP 204 cannot determine why the non-AP STA 206 is unavailable (e.g., AP 204 is unsure if unavailability is due to interference, Basic NAV, or coexistence). The lack of ICR response may lead to unnecessary transmission failures, medium inefficiency, inefficient scheduling at the AP 204. Without unavailability start time, the non-AP STA 206 may over-allocate the Unavailability Duration which may lead to throughput degradation. Knowledge of the coexistence unavailability start time may enable the AP 204 to implement better scheduling (e.g., to STAs that are available).

The illustrated embodiment allows the non-AP STA 206 to provide the AP 204 an unavailability start time and unavailability duration due to in-device coexistence. For instance, the ICR may include an Unavailability Duration field that includes bits (e.g., 9 bits) that indicate the duration of unavailability, and an Unavailability Target Start Time field that includes bits (e.g., 9 bits) that indicate the start time of the unavailability.

However, it may be desirable for the non-AP STA 206 to indicate other unavailability aspects. For example, since APs initiate the TXOP/Frame exchanges with an ICF frame during a coexistence (Coex) session, some embodiments herein provide the client (e.g., non-AP STA) a mechanism to indicate the following in the ICR. In some embodiments, the client may use the ICR to indicate that it is available if there is no upcoming unavailability at the ICR transmission time (or want to cancel previously indicated unavailability). In some embodiments, the client may use the ICR to indicate that it is unavailable, and the unavailability duration is unknown (indefinite) at the ICR transmission time.

In some embodiments, the following rules for unavailability encoding may be used. In some embodiments, a non-AP STA may set the Unavailability Duration field to 0 to indicate that it is available. Setting the field to a predefined field value (e.g., zero) may indicate to the AP that a previous indicated unavailability is canceled or that the non-AP STA does not indicate a future unavailability (e.g., no upcoming unavailability durations). In some embodiments, the predefined field value may be zero. The Unavailability Target Start Time field may be reserved in the case where the Unavailability Duration field is set to 0.

In some embodiments, a Multi-TID Block Acknowledgment (M-BA) may not include Per Association Identifier (AID) Traffic Identifier (TID) Information field for feedback or include one but with some fields such as one or more of the Block Ack Starting Sequence Control and Block Ack Bitmap subfield being absent subject to further signaling indications (based on one or more field value indication).

In some embodiments, a non-AP STA may set the Unavailability Duration field to a predefine field value (e.g., all ones) to indicate an indefinite (e.g., unknown) unavailability duration from the Unavailability Starting Time indicated in the Unavailability Target Start Time field.

There are currently additional Ultra High Reliability (UHR) Mode Enablement Notification Frame Shortcomings. In some embodiments, there is a consideration for enabling Dynamic Unavailability Operation (DUO) Mode per link by sending a UHR Mode Enablement Notification frame on each link where Coex will happen to indicate the start or end of the in-device coexistence activities. DUO mode allows devices to dynamically manage their availability for communication on specific links via the ICF/ICR signaling, providing greater flexibility for multi-band operations, power-saving mechanisms, and interference management. However, the current mechanism has the following shortcomings for a non-AP MLD. There is no link identification indication, and no specific timing when the AP responds and when the DUO Mode starts/ends.

For example, in an embodiment where there is Coex on 2.4 GHz (link one) and 5 GHz (link two) it may be desirable to be able to use link IDs to send Coex in a single frame for both links. Further, in some embodiments a timeout may be used for the DUO mode. For instance, in some embodiments, once this ten milliseconds timeout expires, the session will be automatically activated. This may allow the session to start without a frame back from the AP.

Some embodiments may provide similar functionalities to the EML OMN frame exchange in 802.11be. This may avoid regression for Multi-link device compared to 802.11be functionalities. Some embodiments herein provide enhancements to the UHR Mode Enablement Notification frame to address the shortcomings above.

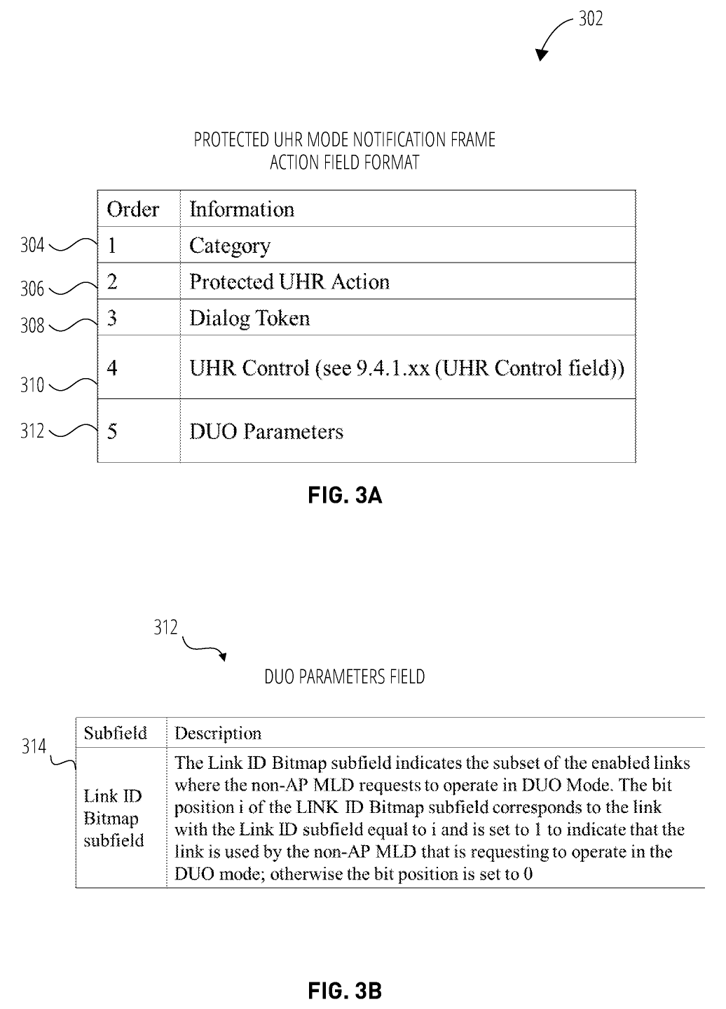

FIG. 3A illustrates an example table 302 for a protected UHR mode notification frame action field format in accordance with some embodiments. The non-AP STA may send the AP a UHR mode notification frame in the format outlined in the table 302. The UHR mode enablement notification frame may include a category field 304, a protected UHR action field 306, a dialog token field 308, a UHR control field 310, and a DUO parameters field 312.

The category field 304 may identify the frame as a management action frame. The protected UHR action field 306 may indicate a specific action related to UHR. The dialog token field 308 may be used for tracking requests and responses. The UHR control field 310 may include parameters specific to UHR mode enablement.

The DUO parameters field 312 may include a link ID Bitmap subfield to indicate the link(s) where DUO mode is enabled or disabled. In-device Coexistence (Coex) could happen on different links independently. Accordingly, the link ID bitmap subfield may be used to indicate whether DUO mode for the links is enabled or disabled independently.

FIG. 3B illustrates an example DUO parameters field 312 in accordance with some embodiments. As shown, the DUO parameters field 312 may include a Link ID Bitmap subfield 314. The Link ID Bitmap subfield 314 may indicate the subset of the enabled links where the non-AP MLD requests to operate in DUO Mode. In some embodiments, the bit position i of the LINK ID Bitmap subfield 314 corresponds to the link with the Link ID subfield equal to i and may be set to 1 to indicate that the link is used by the non-AP MLD that is requesting to operate in the DUO mode; otherwise the bit position may be set to 0. Accordingly, the bits may be used to indicate which links have DUO mode enabled.

Accordingly, in some embodiments the Link ID Bitmap subfield 314 may be added in the DUO Parameters field 312 to indicate the link(s) where DUO mode is enabled or disabled. In some embodiments, the UHR Mode Enablement Notification frame may carry a DUO Parameters field 312 in the UHR Mode Enablement Notification frame Action field (e.g., the format shown in table 302).

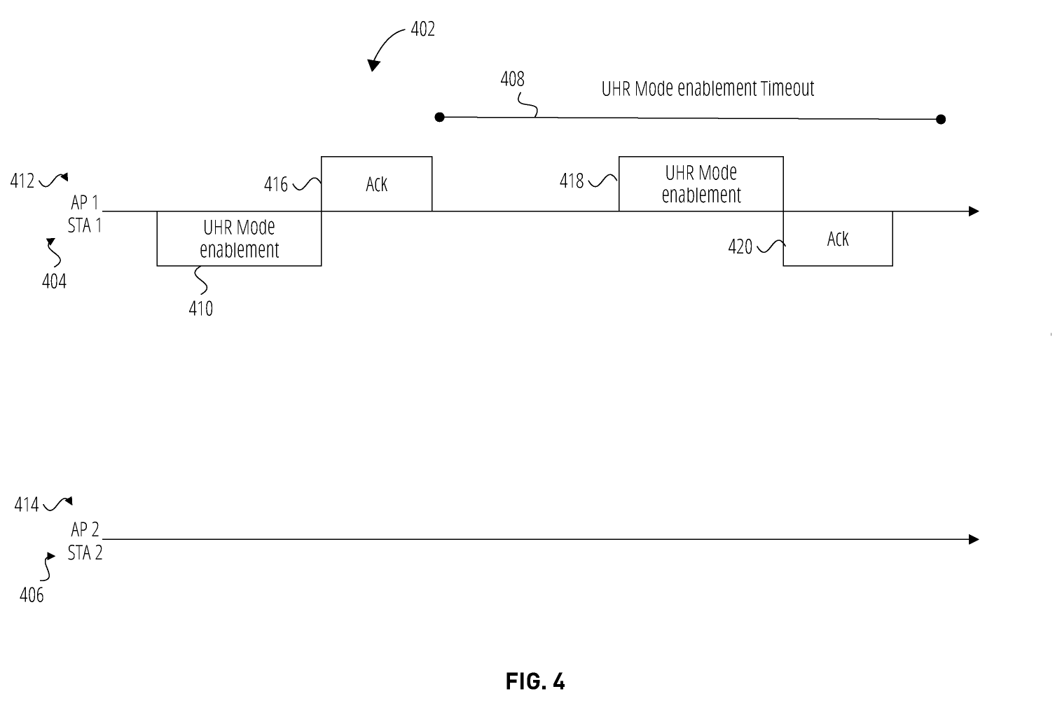

FIG. 4 illustrates an example signaling diagram 402 for a UHR Mode Enablement Notification Frame with a timeout interval (e.g., UHR Mode Enablement Timeout interval 408) in accordance with some embodiments. As shown, a client device may be a non-AP multi-link device (MLD) that includes multiple STAs (e.g., STA1404 and STA2406) that are operating on different links to multiple APs (e.g., AP1412 and AP2 414). Note that AP1 412 and AP2414 may be included on the same networking device. For example, the client device may be operating using two different links with an AP MLD. DUO mode may allow a non-AP STA to dynamically manage and indicate unavailability on specific link.

In some embodiments, when a non-AP STA intends to enable the DUO mode with its associated DUO AP, the non-AP STA (affiliated with the non-AP MLD) may transmit an UHR Mode enablement Notification frame with DUO mode subfield of the UHR control field of the frame set to 1 to the AP. In the illustrated embodiment, the STA1 404 sends the AP1 412 a UHR Mode Enablement Notification frame 410. The UHR Mode Enablement Notification frame 410 includes a DUO mode subfield of the UHR control field of the frame set to 1. Note that the UHR Mode Enablement Notification frame 410 may use the Link ID Bitmap subfield discussed with reference to FIG. 3A and FIG. 3B to indicate enablement of DUO mode on multiple links. In response, the AP1 412 may send an ACK message 416 to acknowledge that it received the UHR Mode Enablement Notification frame 410.

An AP affiliated with the AP MLD can successfully transmit an UHR Mode enablement Notification frame, after the AP is ready to serve the non-AP STA in the DUO operation, within a UHR Mode Enablement Timeout interval 408, as a response to the received UHR Mode Enablement Notification frame 410, to the non-AP STA. For example, in the illustrated embodiment, AP1 412 sends STA1 404 a UHR Mode enablement Notification frame 418 during the UHR Mode Enablement Timeout interval 408. The STA1 404 may send an ACK message 420 to the AP1 412 in response.

In some embodiments, the UHR Mode Enablement Timeout interval 408 starts at the end of the PPDU[+SigExt] that is transmitted by the AP (affiliated with the AP MLD) carrying the immediate acknowledgement (e.g., ACK message 416) to the UHR Operating Mode Notification frame (e.g., UHR Mode Enablement Notification frame 410) transmitted by the non-AP STA (affiliated with the non-AP MLD). For instance, in the illustrated embodiment, the UHR Mode Enablement Timeout interval 408 begins after the ACK message 416 sent by the AP1 412 in response to the UHR Mode Enablement Notification frame 410 from the STA1 404.

The UHR Control field of the UHR Mode enablement Notification frame 418 transmitted by the AP (affiliated with the AP MLD) may be set to the same value as the UHR Control field in the received UHR Mode Enablement Notification frame 410 from the non-AP STA (affiliated with the non-AP MLD). This may be used to confirm that the AP1 412 correctly received the UHR Control information in the UHR Mode Enablement Notification frame 410. In some embodiments, the UHR Mode Enablement Timeout interval 408 may be indicated by an AP (e.g., AP1412) (affiliated with the AP MLD).

In some embodiments, the non-AP MLD and AP MLD may operate in the DUO mode on the corresponding link(s) indicated in the UHR Mode Enablement Notification frame 410 either: at the end of the UHR Mode Enablement Timeout interval 408; or before the end of the UHR Mode Enablement Timeout interval 408, immediately after transmitting an acknowledgment as a response to the received UHR Mode enablement Notification frame 418 from one of the APs (e.g., AP1412) affiliated with the AP MLD, whichever comes first. Accordingly, if the non-AP MLD does not receive UHR Mode enablement Notification frame 418, the non-AP MLD may still begin operating in DUO mode at the end of the UHR Mode Enablement Timeout interval 408. If the non-AP MLD does receive UHR Mode enablement Notification frame 418, the non-AP MLD may begin operating in DUO mode after the ACK message 420. The UHR Mode Enablement Timeout interval 408 may allow APs of the AP-MLD to communicate DUO enablement/disablement information to each other.

A similar procedure can be followed for disablement of the DUO mode on one or more links. For example, the non-AP STA may send a second UHR Mode Enablement Notification frame to the AP that indicates the DUO mode is to be disabled. In response, the AP may send an ACK message and a UHR Mode enablement Notification frame with a UHR Control field set to the same value as the UHR Control field sent by the STA. The STA may respond with an ACK. The UHR Mode Enablement Timeout interval may apply to disablement of the DUO mode just as it was described to apply in the enablement procedure.

Some embodiments herein provide a procedure for unavailability encoding to indicate that the STA is available or has indefinite unavailability. Some embodiments herein provide enhancements to the UHR Mode Enablement Notification frame to address the shortcomings in terms of adding a Link ID bitmap for DUO Mode setup and a timeout interval for the response.

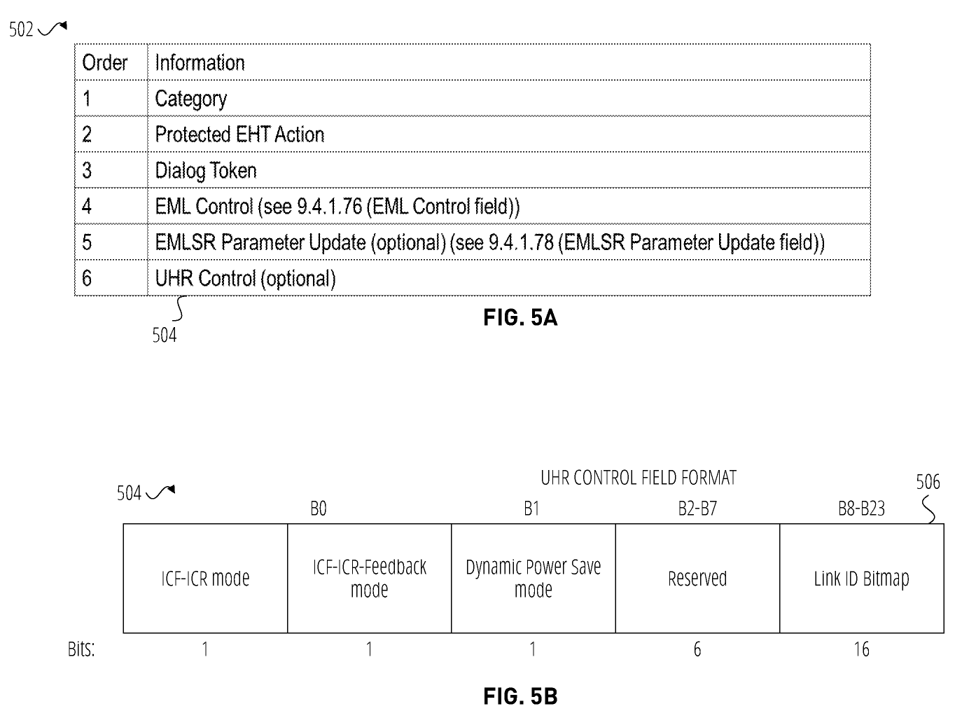

In some embodiments, the Enhanced Multi-Link (EML) Operation Management Notification (OMN) frame may be enhanced to indicate the subset of the enabled links where the non-AP MLD requests to operate in DUO Mode. FIGS. 5A-5C illustrate an example embodiment where the EML OMN frame is used to indicate enablement or disablement of DUO mode on one or more links.

Specifically, FIG. 5A illustrates an example protected EML OMN frame action field format 502 in accordance with some embodiments. The protected EML OMN frame action field format 502 may include a UHR control field 504. The UHR control field 504 may include a bitmap that indicates DUO mode for different links.

For example, FIG. 5B illustrates an example UHR control field 504 in accordance with some embodiments. As shown, the UHR control field 504 may include a Link ID Bitmap subfield 506. The Link ID Bitmap subfield 506 may indicate DUO mode for one or more links. FIG. 5C illustrates an example table 508 that specifies the DUO Mode subfield in accordance with some embodiments. As shown, the Link ID Bitmap subfield 506 may indicate the subset of the enabled links where the non-AP MLD requests to operate in DUO Mode. The bit position i of the Link ID Bitmap subfield corresponds to the link with the Link ID subfield equal to i and is set to 1 to indicate that the link is used by the non-AP MLD that is requesting to operate in the DUO mode; otherwise, the bit position is set to 0.

A non-AP STA may notify its AP (using an ICF or ICR) about its future unavailability due to in-device coexistence whenever it is experiencing an in-device coexistence session. This may enhance the performance by reducing data loss, failed transmissions, and preventing unnecessary transmit rate reduction. The unavailability information may be sent in a frame and may be either solicited or unsolicited.

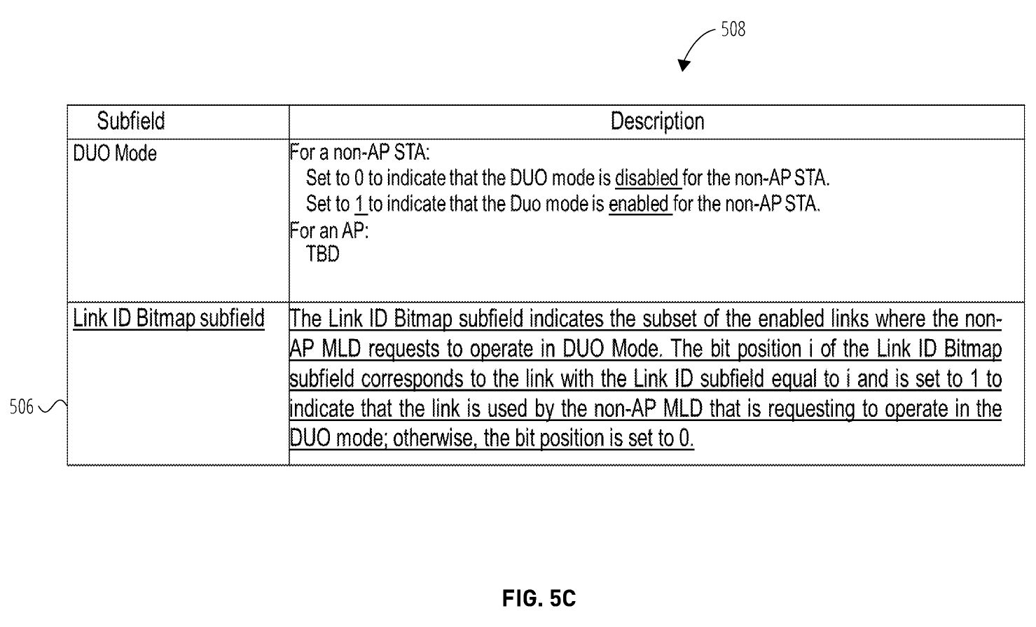

FIG. 6A illustrates an example signaling timeline 602 for solicited transmission of in-device coexistence unavailability information in accordance with some embodiments. As shown, the AP 604 may send a Buffer Status Report Poll (BSRP) ICF 608 to the non-AP STA 606. In response, the non-AP STA 606 may send an ICR (M-BA) 610.

The ICR (M-BA) 610 may include coexistence unavailability information. For example, the coexistence unavailability information may include an unavailability start time and an unavailability duration. The AP 604 may use this information to schedule the DL TXOP 612.

The non-AP STA 606 may inform the AP 604 about an in-device coexistence condition using a management frame. In response the AP 604 may request unavailability information from the client non-AP STA 606. In this way the AP 604 may obtain knowledge about the in-device coexistence operation mode of the non-AP STA 606.

For example, the AP 604 as a transmission opportunity (TXOP) holder can send an ICF 608 to solicit the unavailability information from the client (e.g., non-AP STA 606). The ICF is a Buffer Status Report Poll (BSRP) trigger frame. Once the AP 604 sends the BSRP ICF 608, then the non-AP STA 606 responds to the BSRP ICF 608 with an ICR 610 frame that carries the unavailability information.

The unavailability information may indicate details of a period of unavailability due to in-device coexistence. In the illustrated embodiment the unavailability information in the BSRP ICF 608 includes an unavailability start time and unavailability duration. For example, in the illustrated embodiment, the non-AP STA 606 indicates that the period of unavailability occurs during bits 15 to 7 of the Timing Synchronization Function (TSF). Based on the unavailability information (start time and duration) in the ICR 610, the AP 604 should not schedule for transmission Physical Protocol Data Units (PPDUs) addressed to the non-AP STA 606 that overlaps with its unavailability.

The in-device coexistence future unavailability start time can enable the non-AP STA 606 to indicate its unavailability ahead of time to the AP 604. The reasons why it may be useful for the non-AP STA 606 to indicate the unavailability start time include the following. Due to a busy medium, the non-AP STA 606 may not have access to the channel right before start time. Further, without the Unavailability information, the AP 604 cannot determine why the non-AP STA 606 is unavailable (e.g., AP 604 is unsure if unavailability is due to interference, Basic NAV, or coexistence). The lack of ICR response may lead to unnecessary transmission failures, medium inefficiency, inefficient scheduling at the AP 604. Without unavailability start time, the non-AP STA 606 may over-allocate the Unavailability Duration which may lead to throughput degradation. Knowledge of the coexistence unavailability start time may enable the AP 604 to implement better scheduling (e.g., to STAs that are available).

The illustrated embodiment allows the non-AP STA 606 to provide the AP 604 an unavailability start time and unavailability duration due to in-device coexistence. For instance, the ICR may include an Unavailability Duration field that includes bits (e.g., 9 bits) that indicate the duration of unavailability, and an Unavailability Target Start Time field that includes bits (e.g., 9 bits) that indicate the start time of the unavailability.

However, it may be desirable for the non-AP STA 606 to indicate other unavailability aspects. For example, since APs initiate the TXOP/Frame exchanges with an ICF frame during a coexistence (Coex) session, some embodiments herein provide the client (e.g., non-AP STA) a mechanism to indicate the following in the ICR. In some embodiments, the client may use the ICR to indicate that it is available if there is no upcoming unavailability at the ICR transmission time (or want to cancel previously indicated unavailability). In some embodiments, the client may use the ICR to indicate that it is unavailable, and the unavailability duration is unknown (indefinite) at the ICR transmission time.

In some embodiments, the following rules for unavailability encoding may be used. In some embodiments, a non-AP STA may set the Unavailability Duration field to 0 to indicate that it is available. Setting the field to zero may indicate to the AP that a previous indicated unavailability is canceled or that the non-AP STA does not indicate a future unavailability (e.g., no upcoming unavailability durations). The Unavailability Target Start Time field may be reserved in the case where the Unavailability Duration field is set to 0.

In some embodiments, a non-AP STA may set the Unavailability Duration field to all ones to indicate an indefinite (e.g., unknown) unavailability duration from the Unavailability Starting Time indicated in the Unavailability Target Start Time field.

There are currently additional UHR Mode Enablement Notification Frame Shortcomings. In some embodiments, there is a consideration for enabling Dynamic Unavailability Operation (DUO) Mode per link by sending a UHR Mode Enablement Notification frame on each link where Coex will happen to indicate the start or end of the in-device coexistence activities. DUO mode allows devices to dynamically manage their availability for communication on specific links via the ICF/ICR signaling, providing greater flexibility for multi-band operations, power-saving mechanisms, and interference management. However, the current mechanism has the following shortcomings for a non-AP MLD. There is no link identification indication, and no specific timing when the AP responds and when the DUO Mode starts/ends.

For example, in an embodiment where there is Coex on 2.4 GHz (link one) and 5 GHz (link two) it may be desirable to be able to use link IDs to send Coex in a single frame for both links. Further, in some embodiments a timeout may be used for the DUO mode. For instance, in some embodiments, once this ten milliseconds timeout expires, the session will be automatically activated. This may allow the session to start without a frame back from the AP.

Some embodiments may provide similar functionalities to the EML OMN frame exchange in 802.11be. This may avoid regression for Multi-link device compared to 802.11be functionalities. Some embodiments herein provide enhancements to the UHR Mode Enablement Notification frame to address the shortcomings above.

FIG. 6B illustrates an example signaling timeline for solicited transmission of in-device coexistence unavailability information in accordance with some embodiments. As shown, the non-AP STA 606 may send a BSRP ICF 616 to the AP 604. The BSRP ICF 616 may include coexistence unavailability information. For example, the coexistence unavailability information may include an unavailability start time and an unavailability duration. The AP 604 may use this information to schedule the DL TXOP 614.

In some embodiments, a cross link in-device coexistence indication may be used to indicate in-device coexistence for other links. An STA may experience in-device coexistence that may impact its availability over multiple links (e.g., 5 and 6 GHz links). Currently, an STA can indicate its unavailability on the same link where it transmits the frame with in-device coexistence information. It may be desirable to extend this functionality to enable an STA to indicate its unavailability over one or more link(s).

In some embodiments control frame signaling may be used to indicate the link(s) to which the in-device coexistence unavailability applies. For example, some embodiments may extend the ICF (BSRP) and ICR (Multi-Block Acknowledgment (M-BA)) to indicate the link(s) to which the in-device coexistence unavailability applies. For instance, some embodiments may include a Link ID Bitmap in the ICF or ICR as shown in FIG. 6A and FIG. 6B. In some embodiments, the bit position i of the LINK ID Bitmap corresponds to the link with the Link ID subfield equal to i and may be set to 1 to indicate that the link is used by the non-AP MLD that is requesting to operate in the DUO mode; otherwise the bit position may be set to 0. Accordingly, the bits may be used to indicate which links have DUO mode enabled.

In some embodiments, management frame signaling may be used to indicate the link(s) to which the in-device coexistence unavailability applies. A Target Wake Time (TWT) Information frame can be used to indicate the unavailability on same link or on a cross link. However, the TWT Information frame has few shortcomings. First, the TWT Information frame currently does not allow an STA to indicate the future unavailability start time. Second, the TWT Information frame currently is only allowed to indicate a single cross-link unavailability. Some embodiments herein provide enhancements to the TWT information frame for UHR. Specifically, some embodiments herein propose handling of in-device coexistence over multiple links using the TWT information frame.

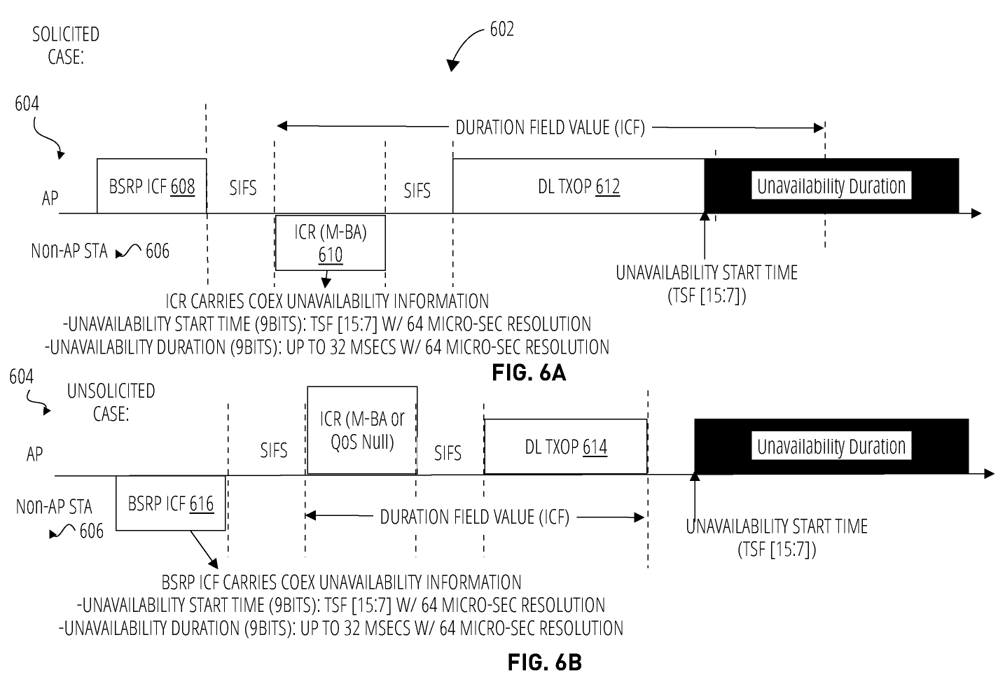

FIG. 7 illustrates an example flexible TWT operation 702 using TWT information frame 704 in accordance with some embodiments. The flexible TWT operation 702 may allow an STA to indicate the unavailability starting from the ACK 706 of the TWT information frame 704 till the future TSF indicated in Next TWT field 708 (equivalent to unavailability duration). In some embodiments, the TWT information frame 704 may be used to send a notification for the current link or a cross link notification for one other link. For example, the STA may use the TWT information frame 704 to inform the AP of unavailability due to in-device coexistence on one other link that is not the link where the TWT information frame 704 is sent.

However, the problem with some embodiments that use the TWT information frame 704 is that there is no indication of when the unavailability duration starts. In such embodiments, the unavailability duration is limited to begin after the ACK 706. Some embodiments herein enhance TWT signaling such that a start time for the unavailability duration due to in-device coexistence may be signaled.

Another limitation of the illustrated TWT information frame 704 is that only one link may be indicated. Accordingly, to send the unavailability duration for two links, two TWT information frames would need to be sent thereby increasing the signaling overhead and power consumption. Some embodiments herein enhance the TWT signaling to allow the STA to indicate multiple links in a single TWT information frame.

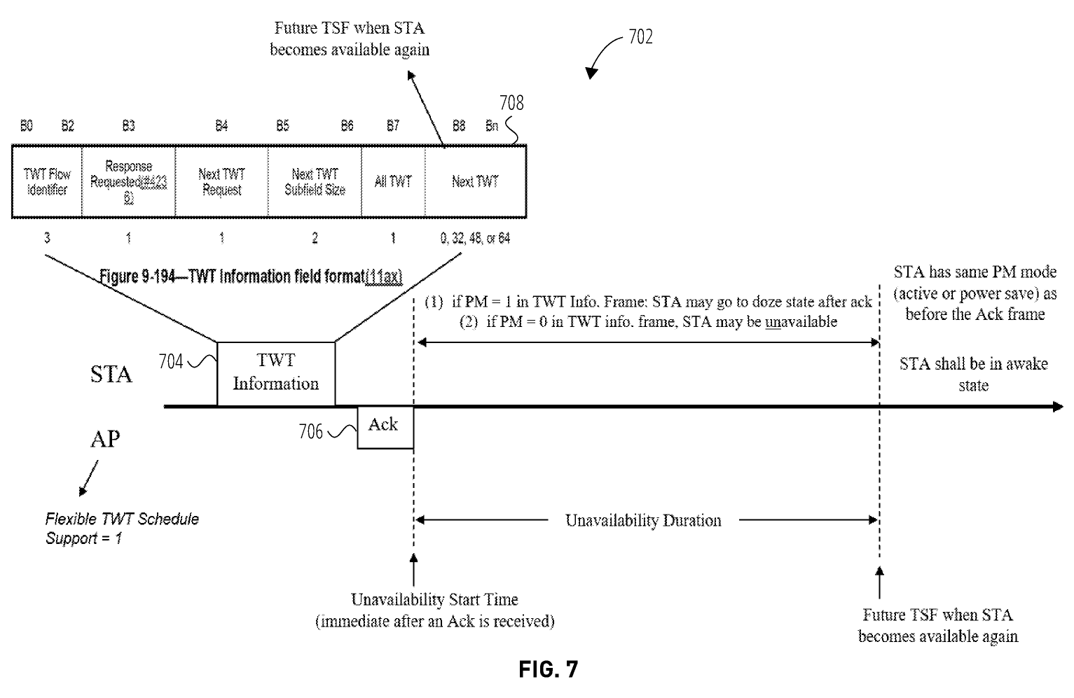

FIG. 8 illustrates an example Multi-Link Operation (MLO) Link Info element 802 that may be included in a TWT information frame in accordance with some embodiments. The MLO Link Info element 802 may be carried in the TWT Information frame to convey the link unavailability in the TWT information frame is intended. In some embodiments exactly one bitin the Link ID Bitmap subfield 804 of the MLO Link Info element 802 may be set to 1 to indicate the unavailable link. In such embodiments, only one link at a time may be indicated as unavailable due to in-device coexistence.

In some embodiments, the Link ID Bitmap subfield 804 may be enhanced to indicate multiple links. For instance, in some embodiments exactly one bit in the Link ID Bitmap subfield 804 of the MLO Link Info element 802 shall be set to 1 unless the MLO Link Info element 802 is transmitted in a TWT Information frame. Between an AP MLD and a non-AP MLD associated with the AP MLD, a TWT Information frame may include an MLO Link Info element 802 with one or more bits set to 1 in the Link ID Bitmap subfield to indicate one or more links as unavailable due to in-device coexistence. In some embodiments, the bit position i of the LINK ID Bitmap subfield corresponds to the link with the Link ID subfield equal to i and may be set to 1 to indicate that the link is used by the non-AP MLD that is requesting to operate in the DUO mode; otherwise the bit position may be set to 0. Accordingly, the bits may be used to indicate which links have DUO mode enabled.

In some embodiments, a start time for the unavailability may be included in the TWT information frame. In some embodiments the same unavailability start time may apply to all the links in the Link ID Bitmap subfield 804. In other embodiments different unavailability start times may be indicated for the links in the Link ID Bitmap subfield 804.

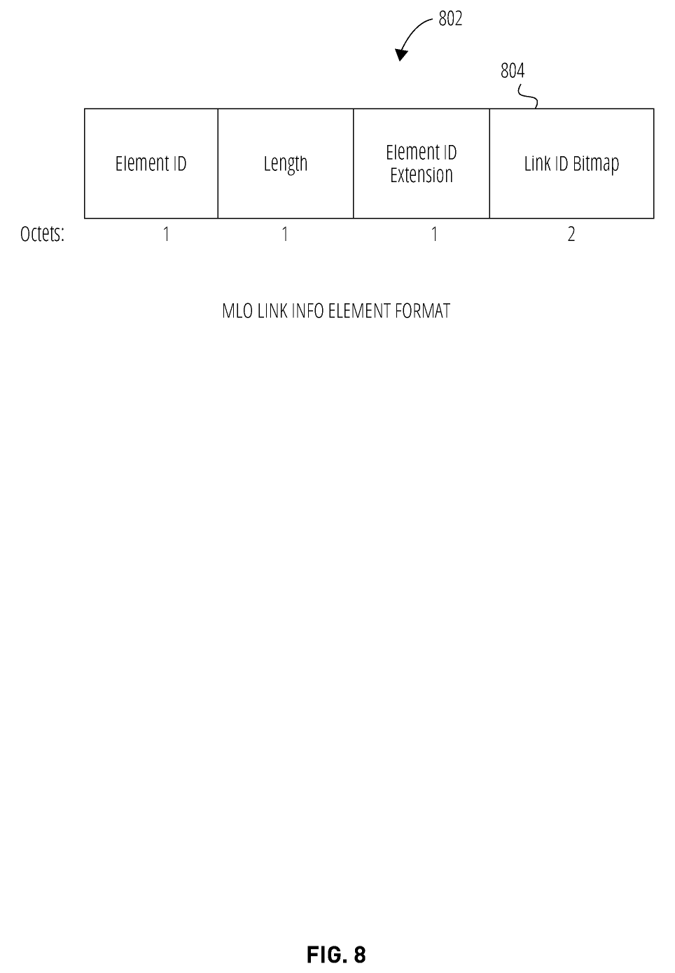

FIG. 9A illustrates an example TWT Information frame Action field 902 in accordance with some embodiments. The TWT Information frame Action field 902 may be included in the TWT Information frame. In the illustrated embodiment, the TWT Information frame Action field 902 includes an unavailability parameters field 904. The unavailability parameters field 904 may include parameters related to the unavailability duration due to in-device coexistence. The parameters in the unavailability parameters field 904 may include unavailability start time to the TWT Information frame.

FIG. 9B illustrates an example unavailability parameters field 904 in accordance with some embodiments. The unavailability parameters field 904 may be included in the TWT Information frame Action field 902 which may be included in the TWT information frame. The unavailability parameters field 904 may include a target unavailability start time subfield 906. The target unavailability start time subfield 906 may indicate when the one or more links indicated in a bitmap of the TWT information frame will begin to be unavailable due to in-device coexistence. For example, the target unavailability start time subfield 906 may indicate TSF[15:7] that corresponds to the start time of the unavailability.

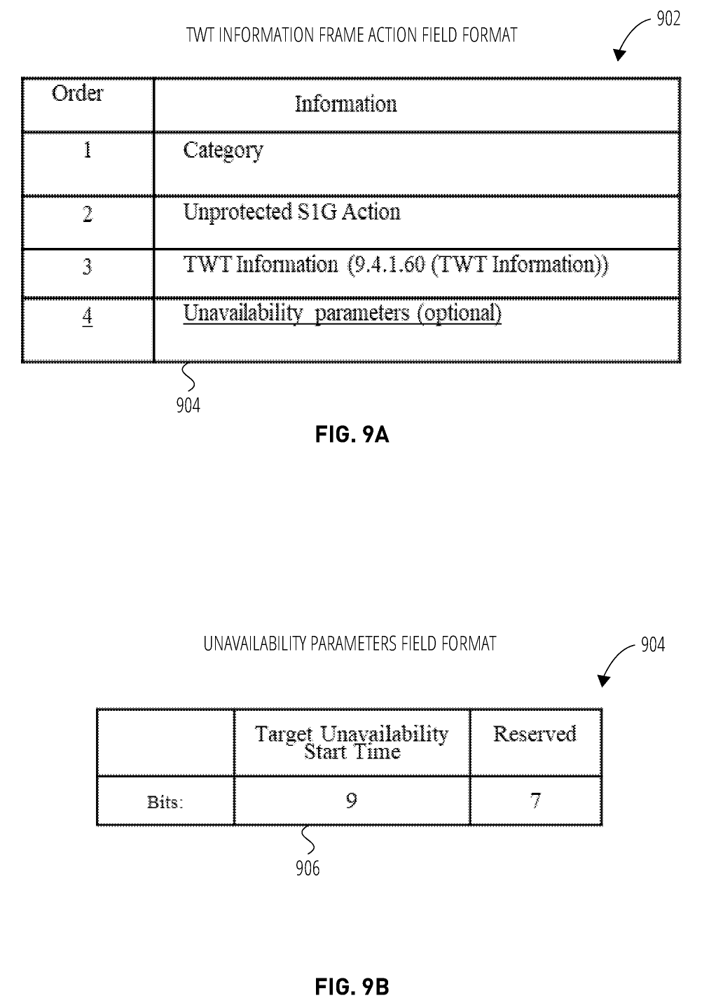

In some embodiments, the TWT information field may include an indication of whether the unavailability parameters are present. FIG. 10 illustrates a TWT Information field 1002 that includes an indication (e.g., unavailability parameters present subfield 1004) of whether the unavailability parameters are present in accordance with some embodiments. The unavailability parameters field may be optionally present when the TWT Information frame is transmitted by a UHR non-AP STA to UHR AP and the unavailability parameters present subfield 1004 in the TWT Information field 1002 is set to 1, and has the format shown in FIG. 10.

In some embodiments, when a UHR non-AP STA sends a TWT Information frame to its associated AP with the Target Unavailability Start Time subfield, the following rules may apply. The corresponding power management mode (PM) mode change and power state change may start immediately at the Unavailability Start time for the same link and as soon as practical for the other link(s) after the individually addressed TWT Information frame exchange.

For cross link behavior, there may be a flexible wake time operation. In some embodiments, the corresponding PM mode change and power state change for the STA of the intended link may start as soon as practical after the individually addressed TWT Information frame exchange rather than immediately.

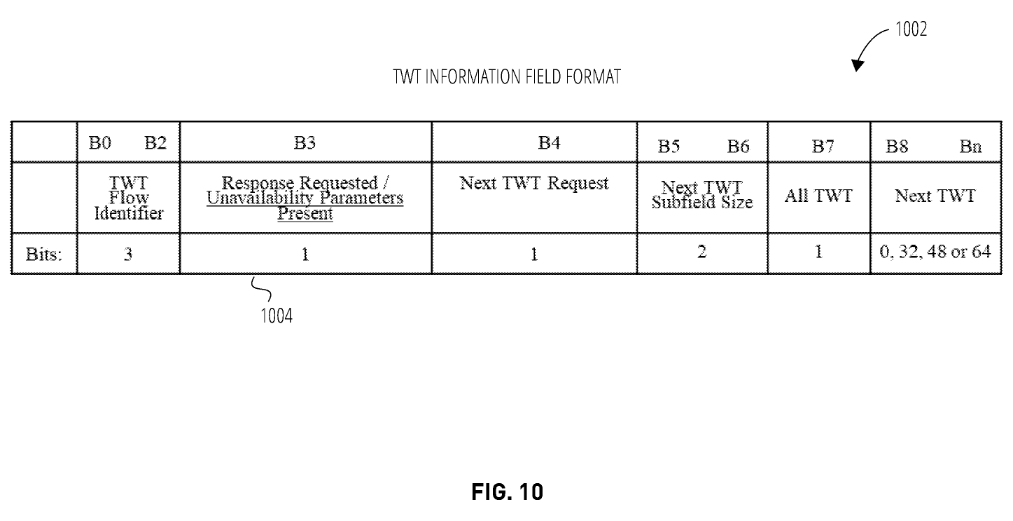

FIG. 11 illustrates a method 1100 performed by a non-AP STA, according to embodiments herein. The illustrated method 1100 includes determining 1102 an in-device coexistence condition. The method 1100 further includes generating 1104 a frame that includes a link ID indication that indicates DUO Mode enablement for links to which the in-device coexistence condition applies. The method 1100 further includes sending 1106 the frame to an AP.

In some embodiments of the method 1100, the link ID indication comprises a link ID bitmap to indicate the links where DUO mode is enabled or disabled. In some such embodiments, the frame is an UHR Mode Enablement Notification frame comprising a UHR Mode Enablement Notification frame Action field, and wherein the UHR Mode Enablement Notification frame Action field comprises a DUO parameter field that includes the link ID bitmap. Certain such embodiments further comprise operating in DUO mode on the links indicated in the frame at a time corresponding to whichever occurs first between: an end of a UHR mode enablement timeout interval, and after receiving an acknowledgment as a response to the frame. In some other such embodiments, the frame is a control frame, and wherein the control frame is an ICF or an ICR frame. In yet some other such embodiments, the frame is a TWT Information frame, wherein the TWT Information frame includes an MLO Link Information element that includes the link ID bitmap that indicates multiple links, and a target unavailability start time.

In some embodiments, the method 1100 further comprises receiving from the AP frame soliciting unavailability information, and sending to the AP a response that includes the unavailability information, wherein the unavailability information includes an unavailability duration field, wherein the unavailability duration field is set to a first predefined field value to indicate that the non-AP STA is available or cancelling a previously indicated unavailability, and wherein the unavailability duration field is set to a second predefine field value to indicate an indefinite or unknown unavailability duration. In some such embodiments, the frame is an ICF or PPDU that carries data or management frame, and wherein the response is an ICR frame or a control response frame. In some other such embodiments, the frame comprises an M-BA that does not include a Per AID TID Information field for feedback based on values of the unavailability duration field. In yet some other such embodiments, the frame comprises an M-BA that includes a Per AID TID Information field with one or more of the Block Ack Starting Sequence Control and Block Ack Bitmap subfield being absent based on values of the unavailability duration field.

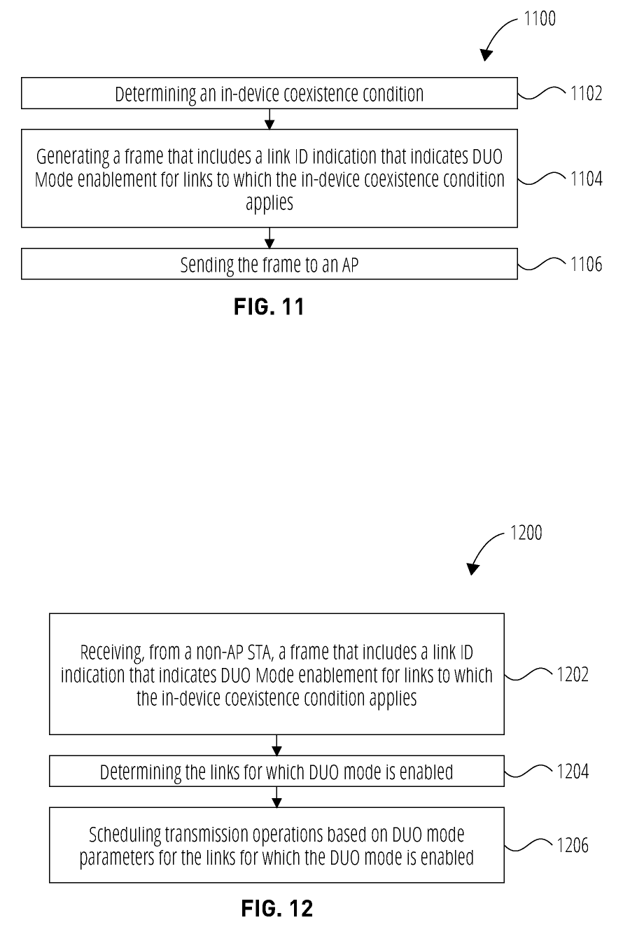

FIG. 12 illustrates a method 1200 performed by an AP, according to embodiments herein. The illustrated method 1200 includes receiving 1202, from a non-AP STA, a frame that includes a link ID indication that indicates DUO Mode enablement for links to which the in-device coexistence condition applies. The method 1200 further includes determining 1204 the links for which DUO mode is enabled. The method 1200 further includes scheduling 1206 transmission operations based on DUO mode parameters for the links for which the DUO mode is enabled.

In some embodiments of the method 1200, the link ID indication comprises a link ID bitmap to indicate the links where DUO mode is enabled or disabled. In some such embodiments, the frame is an UHR Mode Enablement Notification frame comprising a UHR Mode Enablement Notification frame Action field, and wherein the UHR Mode Enablement Notification frame Action field comprises a DUO parameter field that includes the link ID bitmap. Certain such embodiments further comprise operating in DUO mode on the links indicated in the frame at a time corresponding to whichever occurs first between an end of a UHR mode enablement timeout interval, and after sending an acknowledgment as a response to the frame. In some other such embodiments, the frame is a control frame, and wherein the control frame is an ICF or an ICR frame. In yet some other such embodiments, the frame is a TWT Information frame, wherein the TWT Information frame includes an MLO Link Information element that includes the link ID bitmap that indicates multiple links, and a target unavailability start time.

In some embodiments, the method 1200 further comprises sending to the non-AP STA a frame and receiving from the non-AP STA a response that includes the unavailability information, wherein the unavailability information includes an unavailability duration field, wherein the unavailability duration field is set to a first predefined field value to indicate that the non-AP STA is available or cancelling a previously indicated unavailability, and wherein the unavailability duration field is set to a second predefined field value to indicate an indefinite or unknown unavailability duration.

In some embodiments of the method 1200, the frame is an ICF soliciting unavailability information or PPDU that carries data or management frame, and wherein the response is an ICR frame or a control response frame.

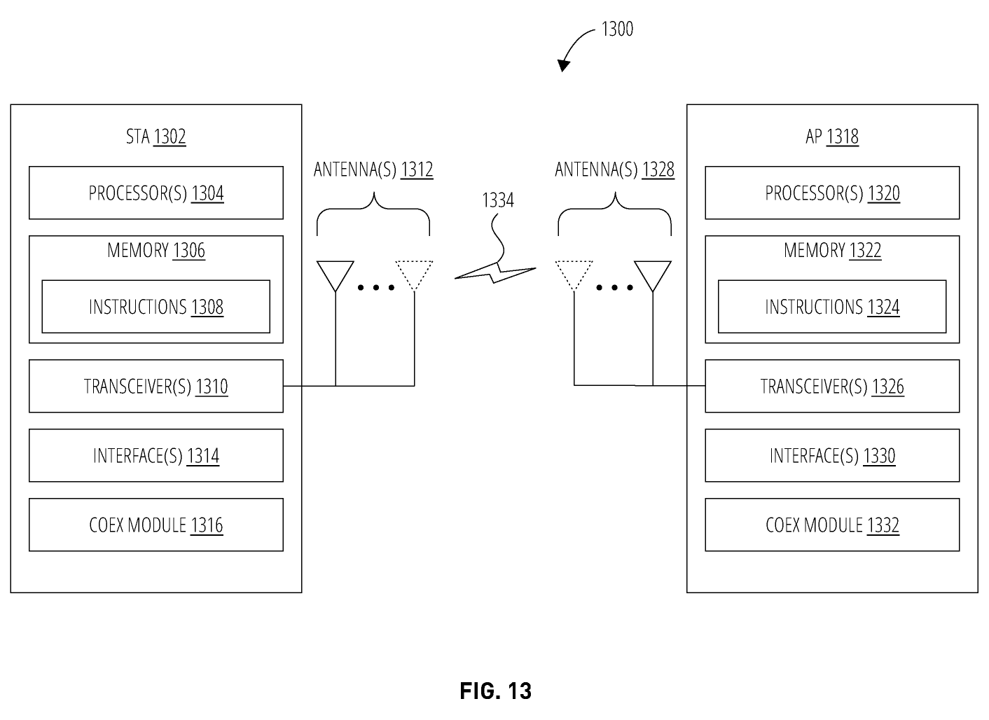

FIG. 13 illustrates a system 1300 for performing signaling 1334 between an STA 1302 and an AP 1318, according to embodiments disclosed herein. The system 1300 may be a portion of a wireless communications system as herein described. The STA 1302 may be, for example, a UE of a wireless communication system. The AP 1318 may be, for example, an access point of a wireless communication system.

The STA 1302 may include one or more processor(s) 1304. The processor(s) 1304 may execute instructions such that various operations of the STA 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The STA 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The STA 1302 may include one or more transceiver(s) 1310 that may include radio frequency (RF) transmitter circuitry and/or receiver circuitry that use the antenna(s) 1312 of the STA 1302 to facilitate signaling (e.g., the signaling 1334) to and/or from the STA 1302 with other devices (e.g., the AP 1318).

The STA 1302 may include one or more antenna(s) 1312 (e.g., one, two, four, or more). For embodiments with multiple antenna(s) 1312, the STA 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the STA 1302 may be accomplished according to precoding (or digital beamforming) that is applied at the STA 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the STA 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The STA 1302 may include one or more interface(s) 1314. The interface(s) 1314 may be used to provide input to or output from the STA 1302. For example, an STA 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi^{®}, Bluetooth®, and the like).

The STA 1302 may include a Coex module 1316. The Coex module 1316 may be implemented via hardware, software, or combinations thereof. For example, the Coex module 1316 may be implemented as a processor, circuit, and/or instructions 1308 stored in the memory 1306 and executed by the processor(s) 1304. In some examples, the Coex module 1316 may be integrated within the processor(s) 1304 and/or the transceiver(s) 1310. For example, the Coex module 1316 may be implemented by a combination of software components (e.g., executed by a DSP or a general processor) and hardware components (e.g., logic gates and circuitry) within the processor(s) 1304 or the transceiver(s) 1310.

The Coex module 1316 may be used for various aspects of the present disclosure, for example, aspects of FIG. 1 through FIG. 12.

The AP 1318 may include one or more processor(s) 1320. The processor(s) 1320 may execute instructions such that various operations of the AP 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The AP 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The AP 1318 may include one or more transceiver(s) 1326 that may include RF transmitter circuitry and/or receiver circuitry that use the antenna(s) 1328 of the AP 1318 to facilitate signaling (e.g., the signaling 1334) to and/or from the AP 1318 with other devices (e.g., the STA 1302).

The AP 1318 may include one or more antenna(s) 1328 (e.g., one, two, four, or more). In embodiments having multiple antenna(s) 1328, the AP 1318 may perform MIMO, digital beamforming, analog beamforming, beam steering, etc., as has been described.

The AP 1318 may include one or more interface(s) 1330. The interface(s) 1330 may be used to provide input to or output from the AP 1318. For example, an AP 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The AP 1318 may include a Coex module 1332. The Coex module 1332 may be implemented via hardware, software, or combinations thereof. For example, the Coex module 1332 may be implemented as a processor, circuit, and/or instructions 1324 stored in the memory 1322 and executed by the processor(s) 1320. In some examples, the Coex module 1332 may be integrated within the processor(s) 1320 and/or the transceiver(s) 1326. For example, the Coex module 1332 may be implemented by a combination of software components (e.g., executed by a DSP or a general processor) and hardware components (e.g., logic gates and circuitry) within the processor(s) 1320 or the transceiver(s) 1326.

The Coex module 1332 may be used for various aspects of the present disclosure, for example, aspects of FIG. 1 through FIG. 12.

Embodiments contemplated herein include an apparatus comprising means to perform one or more elements of the method 1100. This apparatus may be, for example, an apparatus of an STA (such as STA 1302 as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of an STA (such as a memory 1306 of an STA 1302, as described herein).

Embodiments contemplated herein include an apparatus comprising logic, modules, or circuitry to perform one or more elements of the method 1100. This apparatus may be, for example, an apparatus of an STA (such as an STA 1302, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of an STA (such as an STA 1302, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of an STA (such as a processor(s) 1304 of an STA 1302, as described herein). These instructions may be, for example, located in the processor and/or on a memory of the STA (such as a memory 1306 of an STA 1302, as described herein).

Embodiments contemplated herein include an apparatus comprising means to perform one or more elements of the method 1200. This apparatus may be, for example, an apparatus of an AP (such as an AP 1318, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of an AP (such as a memory 1322 of an AP 1318, as described herein).

Embodiments contemplated herein include an apparatus comprising logic, modules, or circuitry to perform one or more elements of the method 1200. This apparatus may be, for example, an apparatus of an AP (such as an AP 1318, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of an AP (such as an AP 1318, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of an AP (such as a processor(s) 1320 of an AP 1318, as described herein). These instructions may be, for example, located in the processor and/or on a memory of the AP (such as a memory 1322 of an AP 1318, as described herein).

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with an STA or AP as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a non-access point (AP) station (STA), the method comprising:
determining an in-device coexistence condition;
generating a frame that includes a link identifier (ID) indication that indicates Dynamic Unavailability Operation (DUO) Mode enablement for links to which the in-device coexistence condition applies; and
sending the frame to an AP.

2. The method of claim 1, wherein the link ID indication comprises a link ID bitmap to indicate the links where DUO mode is enabled or disabled.

3. The method of claim 2, wherein the frame is an Ultra High Reliability (UHR) Mode Enablement Notification frame comprising a UHR Mode Enablement Notification frame Action field, and wherein the UHR Mode Enablement Notification frame Action field comprises a DUO parameter field that includes the link ID bitmap.

4. The method of claim 3, further comprising operating in DUO mode on the links indicated in the frame at a time corresponding to whichever occurs first between:
an end of a UHR mode enablement timeout interval; and
after receiving an acknowledgment as a response to the frame.

5. The method of claim 2, wherein the frame is a control frame, and wherein the control frame is an Initial Control Frame (ICF) or an initial Control Response (ICR) frame.

6. The method of claim 2, wherein the frame is a Target Wake Time (TWT) Information frame, wherein the TWT Information frame includes:
a Multi-Link Operation (MLO) Link Information element that includes the link ID bitmap that indicates multiple links; and
a target unavailability start time.

7. The method of claim 1, further comprising receiving, from the AP, a frame soliciting unavailability information; and
sending to the AP a response that includes the unavailability information, wherein the unavailability information includes an unavailability duration field, wherein the unavailability duration field is set to a first predefined field value to indicate that the non-AP STA is available or cancelling a previously indicated unavailability, and wherein the unavailability duration field is set to a second predefine field value to indicate an indefinite or unknown unavailability duration.

8. The further of claim 7, wherein the frame is an Initial Control Frame (ICF) or PPDU that carries data or management frame, and wherein the response is an initial Control Response (ICR) frame or a control response frame.

9. The further of claim 7, wherein the frame comprises a Multi-TID Block Acknowledgment (M-BA) that does not include a Per Association Identifier (AID) Traffic Identifier (TID) Information field for feedback based on values of the unavailability duration field.

10. The further of claim 7, wherein the frame comprises a Multi-TID Block Acknowledgment (M-BA) that includes a Per Association Identifier (AID) Traffic Identifier (TID) Information field with one or more of the Block Ack Starting Sequence Control and Block Ack Bitmap subfield being absent based on values of the unavailability duration field.

11. A method performed by an access point (AP), the method comprising:
receiving, from a non-AP station (STA), a frame that includes a link identifier (ID) indication that indicates Dynamic Unavailability Operation (DUO) Mode enablement for links to which the in-device coexistence condition applies;
determining the links for which DUO mode is enabled; and
scheduling transmission operations based on DUO mode parameters for the links for which the DUO mode is enabled.

12. The method of claim 11, wherein the link ID indication comprises a link ID bitmap to indicate the links where DUO mode is enabled or disabled.

13. The method of claim 12, wherein the frame is an Ultra High Reliability (UHR) Mode Enablement Notification frame comprising a UHR Mode Enablement Notification frame Action field, and wherein the UHR Mode Enablement Notification frame Action field comprises a DUO parameter field that includes the link ID bitmap.

14. The method of claim 13, further comprising operating in DUO mode on the links indicated in the frame at a time corresponding to whichever occurs first between:
an end of a UHR mode enablement timeout interval; and
after sending an acknowledgment as a response to the frame.

15. The method of claim 12, wherein the frame is a control frame, and wherein the control frame is an Initial Control Frame (ICF) or an initial Control Response (ICR) frame.

16. The method of claim 12, wherein the frame is a Target Wake Time (TWT) Information frame, wherein the TWT Information frame includes:
a Multi-Link Operation (MLO) Link Information element that includes the link ID bitmap that indicates multiple links; and
a target unavailability start time.

17. The method of claim 11, further comprising sending to the non-AP STA a frame; and
receiving from the non-AP STA a response that includes the unavailability information, wherein the unavailability information includes an unavailability duration field, wherein the unavailability duration field is set to a first predefined field value to indicate that the non-AP STA is available or cancelling a previously indicated unavailability, and wherein the unavailability duration field is set to a second predefined field value to indicate an indefinite or unknown unavailability duration.

18. The method of claim 11, wherein the frame is an Initial Control Frame (ICF) soliciting unavailability information or PPDU that carries data or management frame, and wherein the response is an initial Control Response (ICR) frame or a control response frame.

19. A non-access point (AP) station (STA) computing apparatus comprising:
a processor; and
a memory storing instructions that, when executed by the processor, configure the apparatus to:
determine an in-device coexistence condition;
generate a frame that includes a link identifier (ID) indication that indicates Dynamic Unavailability Operation (DUO) Mode enablement for links to which the in-device coexistence condition applies; and
send the frame to an AP.

20. The non-AP STA computing apparatus of claim 19, wherein the link ID indication comprises a link ID bitmap to indicate the links where DUO mode is enabled or disabled.
